(19) United States
(12) Patent Application Publication
(10) Pub. No.: US 2009/0275002 A1
(43) Pub. Date: Nov. 5, 2009

(54) Nutrition informatics method

(76) Inventor: Lindsey Hoggle, Gaithersburg, MD (US)

Correspondence Address: NOLD INTELLECTUAL PROPERTY LAW, 101 California Street, Suite 2450, San Francisco, CA, 94111, US

(21) Appl. No.: 12/112,005

(22) Filed: Apr. 30, 2008

(51) Int. Cl. G09B 19/00; G06F 7/00

(52) U.S. Cl. 434/127; 707/100

(57) ABSTRACT

The present invention provides a method for providing a user the information and tools for determining individual nutritional information and requirements particularly pertaining to menus and recipes that are suited to that user and that may be individually and easily tailored in a method that is heretofore unknown in the prior art.

### BACKGROUND OF THE INVENTION

Nutrition Informatics is an emerging sub-specialty in the field of biomedical informatics that encompasses human nutrition and dietetics in a way that integrates science, evidence-based practice, research, computer knowledge, and expertise in electronic information systems for the purpose of supporting optimal nutritional status and health.

The human diet must provide, at a minimum, the following: enough calories to meet daily energy needs, enough of the essential amino acids needed for protein synthesis that the body cannot synthesize from other precursors, essential fatty acids that the body cannot synthesize from other precursors, at least 18 different minerals and micronutrients, some like calcium in large amounts, some like zinc in small amounts, and about a dozen or so vitamins that cannot be synthesized by other precursors in our diet. Other constituents of food (both nutritive and non-nutritive (such as artificial sweeteners)) are discovered each year which add to the list of food and additive values tracked by consumers.

The complexity of food choices available in today's market has made it more difficult to properly assure the proper nutritional intake for the average consumer, help track usage of both desirable and undesirable food components and assimilate individual foods into a nutrient-appropriate meal plan. The present invention provides a method and system for alleviating this problem in a cost effective and efficient manner.

The prior art discloses methods to help users control and monitor the nutritional content of their diets. U.S. Pat. No. 4,954,954 discloses a method and apparatus for preparing a series of daily menus that include foods having preselected characteristics. The menus are prepared from a list containing numerous food items, the caloric content of each item, which food group each item resides, and the applicability of each item for a particular meal. Replacement food items of similar caloric content are recommended by the system. U.S. Pat. No. 5,233,520 discloses an interactive computerized dietary measurement system and process, which can be used by lay people for accurate measurement of the intake of foods. U.S. Pat. No. 5,412,560 discloses a process for evaluating an individual's food choices based upon selected factors and dietary guidelines. U.S. Pat. No. 5,412,564 discloses a system and method for diet control. The consumer carries a smart card, which is inserted into a card reader-writer before purchase transactions. The system allows recording and monitoring of dietary consumption by registering the nutrition in each food purchased via the bar code label. U.S. Pat. No. 5,673,691 discloses an apparatus to control diet and weight using human behavior modification techniques. U.S. Pat. No. 5,954,640 discloses a Nutritional Optimization Method, which employs a health model based on personal diet and health information to recommend at least two nutritional supplements to the user. Economic considerations i.e. budget are accounted for during the recommendation process. U.S. Pat. No. 6,083,006 discloses a personalized nutrition planning system. The user answers a detailed questionnaire in order for the system to determine a daily calorie intake, and recommends preferred nutrients with a created menu to satisfy the calorie intake requirements. U.S. Pat. No. 6,336,136 discloses an internet-based, weight reduction method used to determine the proper course of action for a dieter. The system advises on behavior changes required to attain the user's weight reduction goals. U.S. Pat. No. 6,387,049 discloses a computer-assisted system and method for adjudging the effect of consumable intakes on physiological parameters wherein a consumer records in a database a plurality of consumable identifiers identifying consumables consumed, the amounts of each consumable consumed, times of consumption of each consumable, a plurality of physiological measurements and time of physiological measurements, and such information is computationally related to consumption information, such as nutritional information, linked to the consumable identifier in another database. U.S. Pat. No. 6,953,342 discloses a computer program, method, and system for dynamically and interactively providing nutrition content information for consumables such that a user may monitor, tailor, plan, and review their intake thereof in light of a health-related interest or concern, such as, for example, weight-loss, food allergies, or diabetes or other nutrition affected illnesses or disabilities. U.S. Pat. No. 7,090,638 discloses a dietary menu planning system that receives personal characteristics and food preferences for an individual. The personal characteristics include a desired physiological rate of change for the individual. Based on the physiological rate of change and other personal characteristics, a set of dietary constraints is developed for the individual. A dietary menu plan is created for the individual including food items selected by the individual and with quantities determined to maximize the food preferences of the individual while satisfying the dietary constraints. The creation of the dietary menu plan includes applying an optimization function to maximize the food preferences.

### BRIEF DESCRIPTION OF THE DRAWING

Reference will now be made, by way of example, to the accompanying drawing which shows preferred embodiments of the present invention, and in which:

FIG. 1 shows in schematic form one embodiment of a system for nutrition item selection, recipe, and menu planning.

### DETAILED DESCRIPTION OF THE EMBODIMENTS

In one embodiment the invention discloses a computer-readable medium encoded with a computer program to perform a method for diet selection based on nutrition informatics, said method comprising: setting a user profile, correlating nutrition information with a menu, a food item or a recipe, changing one or more of said nutrition information, menu, food item and a recipe, re-correlate the nutrition information with said menu, food item or recipe. In one embodiment the method correlates nutrition information for each ingredient of a recipe with said ingredient, at least one ingredient of said recipe is changed from the recipe, and the method suggests a replacement for the changed ingredient having nutrition information similar to that of the changed ingredient. In another embodiment the method correlates nutrition information for each ingredient of a recipe with said ingredient, at least part of the nutrition information is changed and the method suggests a replacement ingredient that has nutrition information similar to that of the changed nutrition information. In some embodiments the method suggests at least one of a menu, a food item or a recipe by analyzing the user profile with a set of instructions designed to optimize at least one parameter in the user profile.

In another embodiment the invention discloses a method for diet selection based on nutrition informatics, said method comprising setting a user profile, correlating nutrition information with a menu, a food item or a recipe, changing one or more of said nutrition information, menu, food item and a recipe, re-correlate the nutrition information with said menu, food item or recipe. In one embodiment the method correlates nutrition information for each ingredient of a recipe with said ingredient, at least one ingredient of said recipe is changed from the recipe and the method suggests a replacement for the changed ingredient having nutrition information similar to that of the changed ingredient. In another embodiment the method correlates nutrition information for each ingredient of a recipe with said ingredient, at least part of the nutrition information is changed and the method suggests a replacement ingredient that has nutrition information similar to that of the changed nutrition information. In some embodiments the method suggests at least one of a menu, a food item or a recipe by analyzing the user profile with a set of instructions designed to optimize at least one parameter in the user profile.

In one embodiment the present invention there is disclosed a computer-assisted method for viewing, choosing and measuring nutritional elements of food items, including but not limited to calories, fat, protein, carbohydrate, minerals and vitamins in a particular food, diet, meal, recipe and/or period of time. In one embodiment the amount of nutritional elements of a food and/or drug ingested may be correlated with individual or group physiological parameters, such as weight, blood glucose levels, or red blood cell count. The present invention allows interactive structural and functional interrelationships between the databases recited herein and other claimed aspects of the invention permitting the data structure's functionality to be altered, changed or otherwise manipulated by any vendor, user or both depending on the embodiment of the invention to accomplish functional goals in accordance with the present invention.

In one embodiment the present invention allows immediate access to data from nutrition databases, national food consumption surveys and their corresponding food coding databases.

Some examples of nutritional goals include products, recipes or menus providing: overall good nutrition; more protein and less carbohydrates; mild, moderate or severe restrictions in total fat and sodium; reductions in total fat and fewer calories; fewer calories and less sugar; fewer calories, less sugar and less total fat; fewer calories, more calcium and less saturated fat; more calories, more protein and less sodium; more calories, more protein and more calcium; products providing less saturated fat, less sodium and less cholesterol; and products providing less saturated fat, less total fat and more fiber. Other nutritional goals may also be provided including other combinations of previously listed goals and different types of nutritional goals. The user can select several goals simultaneously or select predetermined combinations of goals. In another embodiment, a set of nutritional goals is determined based on medical information provided by the user or the user's physician through medical records or a computer-based interview. For example if the user has just discovered that her bone density level is sub standard, which indicates a greater risk for bone loss and fractures, she would be able to select ingredients, recipes and menus which focus on increasing and optimizing intake of useable forms of food calcium.

A typical grocery store has between 10,000 to 40,000 food products with ever-changing nutrition ingredients. In one embodiment of the present invention the user may upload information by any means, such as a smart card a bar code reader, etc. on nutritional content by entering the food brand, name or type and quantity or sufficient information to identify the food while in the grocery store, and the program may store and process that information according to parameters set forth in the present invention. Information on food items and their nutrient profiles is available in the prior art. The USDA National Nutrient Database for Standard Reference (Release 20) contains information over 10,000 food items. The present invention also contemplates that manufacturers, stores and the USDA will have databases that are either downloadable by the user, up loadable by the user or searchable by the user using the methods and systems according to the present invention, thus providing a set of information on almost any food item desired.

By “recipe” it is meant at least one component of a set of written instructions for producing a specific food or beverage; also known as a formula. “Recipe” is not limited to one component, but may include many components, as well as directions for the combining of said components. As used herein, a recipe may or may not include the nutritional food values of the individual components.

By “database” it is meant a structured collection of records or data elements. By “data structure” it meant “a physical or logical relationship among data elements, designed to support specific data manipulation functions. Both are intended to be present on any computer-readable medium or computer. By data it is meant a representation of information in a coded manner suitable for communication, interpretation, or processing

By “record” it is meant a piece of data, no matter how small or large.

By “menu” it is understood that the term may have different meanings. “Menu” may assume the culinary definition of a list of food items, or it may be a choice of items on a user interface of a computer.

By “user profile” or “profile” it is meant that set of data and information required by the programs of the invention to function. They may be standard pre-entered data sets or they may be data sets unique to an individual. They can include all physical data such as age, weight, etc. and also food, menu and/or nutrition information. The user profile may have parameters that may be set by the user or pre-calculated.

By “computer” it is meant to cover any device with computing abilities, including, but not limited to: mainframe computers, workstations, personal computers, secure phones, secure faxes, automated teller machines (ATMs), calculators, hand-held organizers, pagers, and cell phones, hand-held devices, networks of individual devices or a machine that inputs data, processes data, stores data, and outputs data. The computer or computer system may execute any operating system including UNIX, Windows, Linux, and others.

As used herein “computer-readable media” includes, but is not limited to portable medium such as a flexible disk, an opto-magnetic disk, a ROM, a CD-ROM or the like, or a memory device internal to the computer system such as a hard disk or the like and medium that is external to a computer or computer system. Moreover, this term should also be understood as including any device which stores a program during a fixed time, such as a volatile memory (RAM) internal to a computer system which constitutes a server or a client when this program is transmitted via a transmission line such as a network like the Internet, or a telephone line or the like.

By “data processing” it is meant systematic operation on data in accordance with a set of rules which results in a change in the data

“Memory” as used herein means but is not limited to any memory, hard drive, or database module and may take the form of volatile or non-volatile memory including, without limitation, magnetic media, optical media, random access memory (RAM), read-only memory (ROM), removable media, or any other suitable local or remote memory component. Any suitable memory may be used, including a hard disk, a floppy disk, a compact disk, or a read only memory chip. In one embodiment, the memory includes software applications and objects.

By “computer program”, “software” and “program” it is meant instructions for a computer. As used herein a computer requires programs to function, said instructions usually being executed by a processor. Computer programs may refer to either an executable program or the source code from which an executable program is derived (e.g., compiled). Computer programs may be categorized along functional lines: system software and software. Many computer programs may run simultaneously on a single computer, a process known as multitasking.

In one embodiment of the present invention the computer program comprises a combination of code segments accessible to and executable by a processor and operable to facilitate monitoring, tailoring, planning, and reviewing intake and output of data based upon the method disclosed herein especially in light of a health-related interest or concern. The code segments may be written in any programming language, including JAVA or C++ and this is a matter of design choice.

Computer code according to the embodiments of the present invention may be written by those skilled in the art and using those languages known to programmers to solve the mathematical problems described by the method herein. Usually, code is written in a programming language that follows one of two main paradigms: imperative or declarative. Source code may be converted into an executable image by a compiler. Once an executable image is requested to be run, the central processor executes the program, instruction by instruction, until termination. Alternatively, computer programs may be executed immediately with the aid of an interpreter, generated by other computer programs, or may be embedded directly into hardware. The details of linear and integer programming are not the subject of the present invention; those techniques are known in the art and the present invention may be converted to software using the disclosure set forth herein without undue experimentation by one having ordinary skill in the art.

Open-source, publicly-available database connecting UPC codes to nutrition information are being developed. Such databases promise to be an invaluable tool for those on restricted diets due to diabetes, food allergies, other health conditions and/or those desiring certain characteristics for their nutrient intake. The present invention contemplates that the system may or may not have a database inherent with the system to provide nutrition information and/or food information necessary to accomplish the tasks described herein. One having ordinary skill in the art will appreciate that whether or not the system has inherent databases, the system will be able access such information via other means, the internet or other data input means such as CDs.

The terms “graphical user interface” (GUI) or “user interface” or “interface” are used interchangeable herein; it is meant to be a type of display format that enables the user to choose commands, start programs, and see lists of files, data sets and other options by pointing to representations, sometimes pictorial representations (icons) and lists of menu items on the screen. It is understood that the term graphical user interface may be used in the singular or in the plural to describe one or more graphical user interfaces and each of the displays of a particular graphical user interface. Further, GUI contemplates any graphical user interface, such as a generic web browser, that processes information in the computer and efficiently presents the information to the user. In one embodiment the GUI provides the user of the computer with an efficient and user-friendly presentation of data provided by the computer or the network. The GUI may comprise a plurality of displays having interactive fields, pull-down lists, and buttons operated by the user. In one embodiment the GUI presents an explorer-type interface and receives commands from the user. In one embodiment the network can accept data from the user of computer via the web browser (e.g., Microsoft Internet Explorer or Netscape Navigator) and return the appropriate HTML, Java, or eXtensible Markup Language (XML) responses.

In one embodiment of the present invention the interface communicates with other computer systems over network such as, for example, in a client-server or other distributed environment via a link. In certain embodiments, the computer receives configuration files or objects from any network for use or for storage in RAM or ROM or other memory. The network facilitates wireless or wire line communication between computer system and any other computers or computing devices. The network may communicate, for example, Internet Protocol (IP) packets, Frame Relay frames, Asynchronous Transfer Mode (ATM) cells, voice, video, data, and other suitable information between network addresses. The network may include one or more local area networks (LANs), radio access networks (RANs), metropolitan area networks (MANs), wide area networks (WANs), all or a portion of the global computer network known as the Internet, and/or any other communication system or systems at one or more locations. In one embodiment, the interface comprises logic encoded in software and/or hardware in a suitable combination and operable to communicate with network usually via a link. In one embodiment an interface may comprise software supporting one or more communications protocols associated with the link and communications network hardware operable to communicate physical signals.

By “nutritional analysis” it is meant a quantitative and qualitative description of the nutrients and possibly non-nutritive components present in a food item. “Nutrient” is defined broadly here to mean any substance assimilated by living things that promotes growth, and also those substances that may not promote growth, but may have no impact, unknown impact or possibly harm growth and are of interest of being regulated by the food consumer.

By “nutritional content” or “nutrient content” or “nutrition information” it is meant the quantity and/or quality of a particular nutrient or nutrients in a substance, food item, recipe, meal, menu, day, month, etc. Nutrition information is understood to be correlated with a particular menu, food item, a recipe, a day, etc. when the nutritional information of a food item, for example, is displayed with that food item for viewing and/or analysis.

By “display items” it is meant that information displayed on the screen or readable media.

In one embodiment of the present invention a computer system may include, but does not necessarily require, each independently, a graphical user interface of any type, a memory, a processor, and an input device such as a keyboard, mouse or touch screen, bar-code reader or any other input device known in the art. Records may be stored in memory and executed or processed by the processor.

In one embodiment the present invention contemplates devices for providing nutritional information using a computer-readable memory located within the device which may store a combination of code segments and a database including food item such as apples, pears, rice, etc. and related nutritional content information and a processor integral with the hand-held device and capable of executing the combination of code segments and access the database to sort the food items into a plurality of lists corresponding to health issues, such as but not limited to caloric content, protein content, carbohydrate content, fat content, vitamin content, mineral content and sugar content. A user interface displays an interactive screen generated by the combination of code segments, the user interface displays the lists and nutritional content information for each food item; and the user interface is coupled with the processor with a capability so a user to may choose a particular food item from the lists and to enter a desired nutritional quantity corresponding to a maximum future intake of one or more nutritional contents. The method may calculate the remaining nutritional quantity based on the difference between the target nutritional value and the related nutrition content information of each selected food item.

In one embodiment the computer program broadly comprises a database (or a code segment to access such) of food items and related nutritional information; a code segment operable to generate user interface for display and a code segment providing for prospective menu planning; and a code segment for generating summaries of past use and user information over a user specifiable or programmable set time period.

The computer program and method disclosed herein is capable of being implemented on any computing device, including but not limited to a desktop or laptop computer; in a preferred embodiment the computer program is stored on and executed by a portable, battery-powered, hand-held device that may or may not be connected to a main frame or other computer via wireless connection. The small hand-held device is more conveniently and less conspicuously carried than a conventional desktop of laptop computer and the user is more likely to enter more data at the time of menu and/or recipe planning thereby increasing consistent and beneficial use of the present invention.

The memory used by the present invention and network connection is alternative or complimentary mechanisms for storing/accessing the computer program of the present invention. In some embodiments, only the memory is included, it being operable to store the program, including the database containing all the information required to operate the method. In other equally preferred embodiments, only the network connection is included, it being operable to provide access via a communication network (e.g., a local area network, a wide area network, or the Internet) to the program, wherein the program is remotely stored. In still other embodiments, both the memory and the network connection are included. In these latter embodiments, a first portion of the program may be stored in the memory and a second portion, possibly the database of food items, may be accessed via the network connection and communication network.

Each software application comprises any software or logic operable to be executed by any computing device.

The present invention contemplates that the user may employ a computing device that is equipped with a bar-code reader or other means for easily and directly inputting data, which may or may not be portable so the user may employ the system and method in an environment external to the kitchen such as a grocery store. By scanning a food item's bar code the food's nutritional content may be entered into the system.

### Example 1

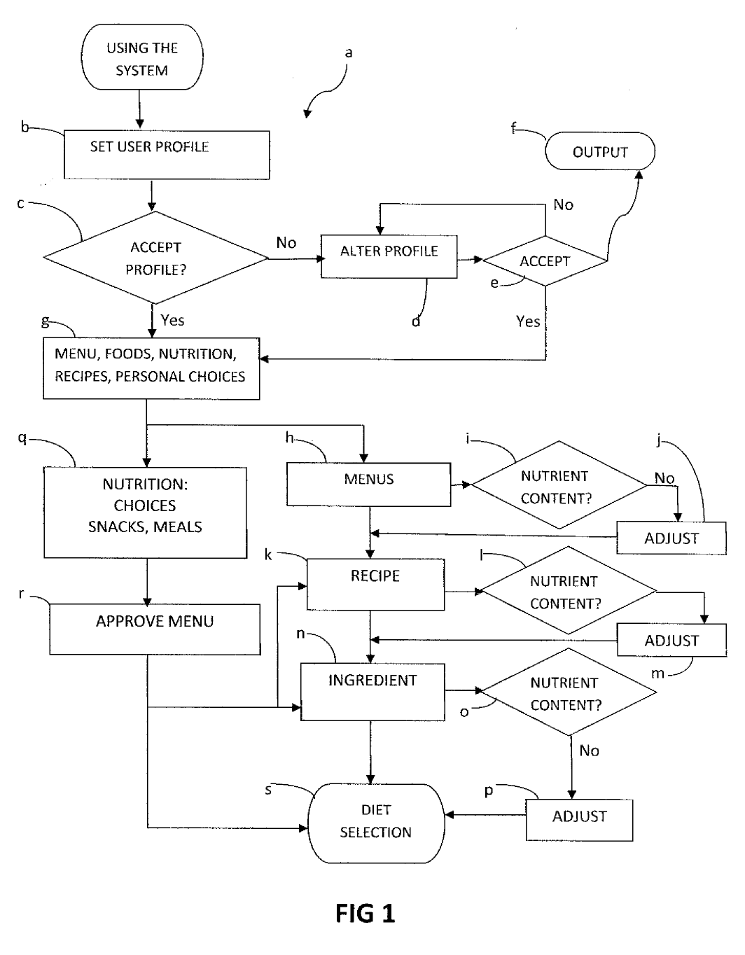

Some embodiments of the invention are described with reference to FIG. 1. In one embodiment the system FIG. 1a, may query a user to determine if this is a new user requiring new user input or to set and/or enter a new user profile FIG. 1b or a returning user who may login to access stored data from a previous session. The invention contemplates that all data from previous uses for each individual and users may be stored in a variety of data fields such as but not limited to individual (personal to the user) and collective nutrition, menus, recipes, favorite and/or most chosen menus and/or recipes, including any known deficiencies such as nutrients and/or vitamins, etc. for each user. The system may have the capability to store multiple “user profiles”, or personal details associated with personal health data and nutritional goals within the database. This may allow for saved recipes, menus and personal data records to be kept with the ability to access user profiles using profile login and password FIG. 1b.

In addition to accessing stored user data, the method contemplates at this step FIG. 1d or any other convenient step a process that allows a user to input into data memory on any information on any food item, menu and/or recipe in any quantity or other information via manual input, user interface menu queries or a text search option from the program and have that record part of the user profile and general memory.

In one embodiment the program will query if this is a new user and the program may, in some embodiments FIG. 1b request input as to user age, weight, gender, height, ethnicity, body type, level of fitness that the program may calculate for the user based on user input in one embodiment of the invention (1-10, 10 being high), level of activity (1-10, 10 being high) and in one embodiment the program may calculate for the user based on user input in one embodiment of the invention), pregnancy status, blood pressure, cholesterol level including LDL and HDL, body fat content, food allergies such as peanuts, shellfish, etc., food insensitivies such as lactose intolerance, medicinal allergies, any medical conditions, such as cancer, chemotherapy, diabetes, or other data that may be used by the system in determining nutrition related diet recommendations that the user is aware of. In the generation of this user profile data or parameters, one having ordinary skill in the art will appreciate it is a matter of engineering design choice and within the abilities of one in the art to design algorithms necessary to use these characteristics to generate a set of data and calculate a set of desired results. As default values one may use nutrient values based on USDA recommendations.

In one embodiment the invention contemplates that the “user” may encompass a group of users all having similar dietary characteristics, such as a group of school age children, a group of hikers, a group of cancer ridden patients, a group of diabetics, etc. and the program may query this. For example, if the user is an overweight teenage, then the user may be able to more quickly access foods commonly in the average diet of a teenager and allow acceptable lower calorie substitutes.

The program may store information, check for accuracy such as impossibility of data, i.e. blood pressure numbers too high or too low to be realistic, and user entry error and continue and generate a user profile for review and acceptance or change.

It is a matter of design choice how much data is described on each user interface screen with the user having the ability in some embodiments to add or remove data fields that are part of the user profile.

In one embodiment a “user profile” is created that consists of the data pertaining to the user. The user profile may contain, for example, sets of data including but not limited to personal data, food items, recipes, nutritional information and menus that the user has chosen in the past or have been otherwise deposited into a dataset available for the purpose of suggesting, inputting, processing, presenting processes as set forth in this invention. Some parameters within the user profile may be altered so as to be set as goals for use with this method. The user will have the opportunity to review and accept this user profile FIG. 1c or change the profile FIG. 1d. In one embodiment FIG. 1d the user may change by adding new menu, recipe and/or food items by creating a new item name and entering information such as but not limited to specific nutrient content of said item. For example, the user would add their favorite recipe for “Breakfast Casserole”, store the recipe for later use and for perhaps the first time, and view the actual nutrient content for a serving of one of their favorite recipes. In some interactive embodiments FIG. 1d the program may also query and/or search for information for such items and then store on the user's request such information in any database appropriate. The system allows for any input of new data by any means for the purpose of enhancing the user profile. The system provides for output at this FIG. 1f stage or any other stage FIG. 1s. Output may consist of menu preview, item preview, printing or data storage or other such functions.

With reference to FIG. 1g the user may elect to work with different areas of the system such as menus or foods or nutrition or recipes or personal choices. The system will determine by user input what part of the system the user wants to work with load the appropriate database, check for new user profile information or other input relevant to the system election by user and present the user with a list of choices on how to proceed. The user may select an entire menu for a day, week or month, from queries presenting different menus stored in databases based on having a recommended nutrient content from data in the user profile FIG. 1b. The method will correlate nutrition information with a menu, a food item or a recipe for example by having the user interface display a list of a menu, a food item and/or a recipe and correlating nutrition information for display and analysis by the user on the user interface. The user interface may display a menu FIG. 1h or entire menu with or without corresponding nutrition information and next to a menu item there is a yes or no query allowing for user interface with the program. The user may choose to review the nutrient content and food content of the menu and/or other items associated with the menu and approve these items FIG. 1i. A user may choose that the nutrient content of 2000 calories for a particular day's menu is too liberal, and change the value to 1800 FIG. 1j. The interactive nature of the system allows the user to interface with the system to vary the nutrition content and have the program suggest alternative menus that have the desired nutrient values. Similar interactions may be had using the system for other variables, such as vitamin D, fat content, etc.

The user may expand the menu to include a single recipe FIG. 1k. The user interface may display a recipe FIG. 1k with or without corresponding nutrition information and next to a recipe item there is a yes or no query allowing for user interface with the program. The user may chose to review the nutrient content and food content of the recipe and/or other items associated with the recipe and approve these items FIG. 1l or adjust the items FIG. 1m. For example a user may choose that the nutrient content of 600 calories for a particular recipe is too restrictive, and change the value to 700 FIG. 1m. The interactive nature of the system allows the user to interface with the system to vary the nutrition content and have the program suggest alternative recipes that have the desired nutrient values. Similar interactions may be had using the system for other variables, such as vitamin D, fat content, etc.

Similarly the system may expand the recipe to include each ingredient with a similar query/response choice for the user from the program FIG. 1l. The user interface may display a particular ingredient FIG. 1n with or without corresponding nutrition information. The user may chose to review the nutrient content and food content of the ingredient item and approve these items FIG. 1o or adjust the items FIG. 1p. For example a user may choose that the nutrient content of 50 calories for a particular ingredient is too high, and change the value to 40 calories FIG. 1p. The system would suggest, based on the 10 calorie decrease in content a lower quantity of ingredient for the recipe, using a lower calorie substitute for the ingredient i.e. an ingredient change. The interactive nature of the system allows the user to interface with the system to vary the nutrition content and have the program suggest alternative recipes that have the desired nutrient values. Similar interactions may be had using the system for other variables, such as vitamin D, fat content, etc.

During menu selection the user may have the option to choose the ethnicity of the type of menu and/or recipes to choose from, i.e., multiple ethnicities, Mexican, American, Italian, German, Chinese, Japanese, Greek, etc. In another embodiment the program may contain data concerning particular types of diet plan already known in the art, such as South Beach Diet, Atkins Diet, Mediterranean Diet, Glycemic Impact Diet, High Fiber Diet, Low Sodium Plan Diet, etc. into the system so that the program may enable the user to use menus from these diet plans. In one embodiment the system will allow the user access to data of a standard set of recipe and menus for use, which is based upon the U.S. Dietary Guidelines or other National Dietary Recommendations.

At all times it is contemplated as an embodiment of the present invention that the program has the option of displaying and/or expanding the data available to the user concerning nutrient values corresponding to any food item/recipe and/menu the program is handling. The user may also proceed in the system and flow from one part to another. In one embodiment the user will simply move the mouse or user interface implement (for example it could be a touch screen and the user will simply point to an item of interest) and the screen will display options allowing for expansion to detail, for example, items of a menu, recipes of a menu, ingredients for a recipe, suggested changes for any ingredients or recipes, said changes taken from database that has similar items, and/or any nutrient information.

In one embodiment the user may be choosing from a type of food items FIG. 1g.

The user may also choose from a list of food taste parameters, such as spicy, salty, sweet, mixed, high in fruits, high in vegetables or totally vegetarian, vegan, low dairy or non dairy, fish dishes, meat dishes, fresh items, canned items, frozen items, cost of food items.

The program may query FIG. 1q user as to whether it is desired nutritional information content for a snack, a meal or set of meals for a day, week, or month, etc. with other time periods and types of meals and snacks possible and envisioned as within ordinary skill in the art, such as breakfast or lunch. The user may enter a snack or one is suggested. The program may calculate recommended nutritional content for the chosen snack, meal or set of meals for a day, week, or month, etc. using U.S. Food and Drug Administration recommended “Daily Intake” amounts based on the user input for any or all of the following: total calories including calories from fat, total fat and saturated fat, trans fat, polyunsaturated fat and monounsaturated fat, total carbohydrates including dietary fiber, soluble fiber, sugars and other carbohydrates, total protein, cholesterol, sodium and potassium, as well as any and/or all vitamins and minerals, caffeine, cholesterol or any other item of interest, and displays on the user interface.

For example, user may start with creating a three-day menu that satisfies the nutrient content needed by a user who has temporary unusually high protein and calorie needs, such as that which occurs with multiple bone fractures. Additional days may be added or the menu used as a cycle to deliver a short-term nutritional goal. Once the nutritional needs of the user have returned to normal less protein intense needs, the menu may be modified, reverted to previous menu design or re-designed entirely to satisfy the long term nutritional needs of the user. One having ordinary skill in the art will appreciate that not all of the above nutritional parameters will be necessary in all circumstances and for ease of use or other convenience certain and/or all of the above nutritional elements may be hidden and/or omitted from the user view or not displayed on the user interface. In a preferred embodiment only a certain number of nutrients are displayed and the user has a choice of whether to include in the display all and/or some other nutrients. Further, the user may choose from user interface display items any of the nutrient parameters such “vitamins”, “minerals” etc. for display on the screen at anytime when working with or choosing from a menu, recipe and/or food item.

In addition, there are other nutritional items that one having ordinary skill in the art would be aware of that one might incorporate into this method without departing from the scope of the present invention. For example, the user may have the capability to “save” recipe or menu types based upon the situation; high calorie, protein and calcium during pregnancy, higher still during lactation, and then a reduced calorie, nutrient dense menu for weight loss after lactation. The user has option to accept or replace any USDA recommended calculated amounts and substitute their own amounts based on any circumstances the user may be aware of. This affords the program with a high level of customization, particularly in view of geographical nutritional differences in foods, processing differences by brands or by changes in composition by manufacturers.

With reference to FIG. 1q the user has the option to more accurately define his nutritional needs and/or desires. The user has the option to choose a particular menu for the particular time period chosen, i.e. a snack, a meal or set of meals for a day, week, or month, etc, with other time periods and types of meals and snacks possible. Based on these choices the program may suggest a set of menus and/or recipes. Previous choices may be retrieved and suggested first. Choices that have been previously ignored or not chosen may be suggested later in the list of choices displayed on the user interface. Also if the user has been losing weight but reaches a “plateau” where weight loss terminates, then user may further modify the menu to include a small reduction in calories.

The user may approve the menu FIG. 1r. Alternatively, the user may in some embodiments, FIG. 1k upon viewing a food item, menu and/or recipe item and/or the nutrient value associated therewith, have the ability to accept and or reject any particular ingredient, food item, menu item or recipe item, and/or combinations thereof, and replace those item(s) with a different item. This allows the user complete control to alter the nutrition content stored in the program.

In one embodiment FIG. 1g a list recipe titles and/or recipes appear on the user interface. The user may select one or more recipes. In one embodiment the user may create unlimited number of menu items and create days, weeks or month of menus, which user may save and assign a “saved name” to. For example light summer menus may be saved for one week and entitled “Summer Menus Mid June”. The user may have the option to expand recipes on the user interface to display specific recipe components and their respective nutrition content for any or all nutrients desiring information on. By selecting an appropriate menu display option the user may compare these nutrients against the calculated recommended amounts and provide quantitative information regarding the comparison. For example, if the calculated recommendation was for no more than 4000 mg of sodium per day, and the user selected food items which well exceeded that, the user would be able to identify higher sodium items and modify and/or replace them with appropriate lower calorie counterparts.

### Example 2

In another example of using the system the user enters the following information into the system: Date of Birth, Gender, Race, Existing Medical Conditions (Chronic & Acute), Family History for specific medical conditions, Height/Weight, Current Diet Restrictions, Desired Modifications to diet and nutritional intake, Medications, Pertinent Lab findings, Herbal and/or Nutritional Supplements, Allergies to Medications and/or Foods. The invention contemplates that some of this information may be entered as a user parameter or “desired parameter” or goal. One example is weight. A user may enter a desired weigh as a parameter. The user enters the following data into the appropriate fields: DOB: Mar. 23, 1978, Gender: Female, Race: White/Caucasian, Existing Medical Conditions: Type II Diabetes, High Blood Pressure, broken leg, Family Medical History Mother with history of breast cancer, father with diabetes, brother died at age 44 from heart attack, sister living with renal disease. Height: 5′3″, Weight: 194 pounds (system translates into 88.2 kg.), Current Diet Restriction(s): 2000 kcal No added Salt diet, Desired Modifications to diet and nutritional intake: Pt selects: High protein for broken bone, Medications: NPH Insulin 20 units each am, 10 each pm, Tylenol for pain, Pertinent Lab Findings: Cholesterol of 230 mg/dl, Herbal and Nutritional Supplements: Ginkgo Baloba 30 mg three times a day, Allergies: Sulfa and shellfish.

The system will provide from the personal data entered the following data:

Body Mass Index value and range from height/weight (with corresponding categories from “underweight” to “Morbidly Obese”, Calorie, protein, fat, carbohydrate content for weight maintenance, List of pre-existing nutritional restrictions or modifications (such as Low Salt, High Calcium, etc.), Suggested age and disease specific modifications based upon user's age and medical conditions (such as high calcium, high iron for teenage girls). A (System Generated Response) would be:

BMI: 34.4 (Obese)

Additional Nutrient Modifications Suggested based upon entered data: Low saturated fat, low cholesterol, (for cholesterol reduction and heart health) high calcium (for bone health)

Health Risk: High for Cardiac events due to family history before age 55.

Approximate Calorie Goal for Weight Maintenance: 2645 Kcal/day

Protein: 132 gm/day (moderately high for bone healing),

Fat: 88 gm/day

Carbohydrate: 330 gm/day

User will be prompted to modify the nutrient requirements for their specific profile and the program can change the parameters set in the user profile. This may include answering additional questions in regards to desired nutrient content and specification of their diet. For example, they may desire high fiber content, organically grown foods and a higher percentage of fresh foods over processed foods. The user may also indicate if they desire snacks on a daily basis.

Recommended Nutrient Composition Changes (user selects any/all): user selects all recommended suggestions which include low cholesterol, low fat and high calcium

Optional Modifications per user preference (drop down list): user selects high fiber

Meal Pattern Selection: User selects Breakfast, Lunch and Dinner with snack at 3 PM and Evening

The user may select: Generate one day meal pattern for Review

Based upon the user's identified desires, the system will then allow user to preview system generated foods and recipes for a day, or multiple days OR build their own menu from scratch. Any food item, recipe and/or menu may be modified by the user according to their desires.

System Generated Day One Menu might begin with a Breakfast having the following nutrient composition: Kellogg's Raison Nut Bran ¾ cup with 8 oz skim milk having 80 Kcal, 8 gm Protein, 12 gm fat, 0 gm cholesterol, 120 mg Na, ×gm Fiber, 150 mg Ca.

In one embodiment the invention contemplates the user may again choose to modify any of the meals, snacks or nutrition choices by adding, removing or modifying items and/or recipes. Once meal patterns for this user have been developed user may also have the following options: Saving the existing menu pattern for set number of days and creating another menu, Selecting or bypassing coordination of “Wellness Prompts” which may include scheduling wellness-related appointments, weight checks, blood pressure readings, blood glucose readings, etc., Entering weight or other readings by date, including days in the past, but not including days in the future and/or generating a “Purchase List” for food and grocery shopping based upon the present menu selected.

Purchase List (If item is used in menu, the system will automatically combine amounts needed and suggest purchasing the next largest typical container/package size for use. For example DAIRY: Half Gallon Skim Milk, 1 lb package Canola Oil Margarine; CEREALS/BREADS: 16 oz Package Raisin Nut Bran Cereal:

FRESH PRODUCE: 1 fresh banana, medium size, 12 oz Package Fresh Spinach Etc.

In the present invention it is contemplated that a user may add a new recipe and “link” or replace items in recipe to a choice of said nutrient items. For example if the user has just discovered a new item on the market which is a low fat, low salt mozzarella cheese that he/she wants to include in his/her favorite Lasagna recipe, the new cheese item may be selected for use in the recipe and the existing Lasagna cheese would/could be removed. In this way the user has modified existing recipes and/or menus to include items which best match their nutritional expectations for foods. For example, the user may search for the zinc content of shellfish, by which the user could search different shellfish, decide to utilize recipes within the system which include shellfish and proceed to selecting a Shrimp Scampi recipe for the dinner on day 1. User adds additional recipes to the meal, verifies the meal's nutritional summary and repeats the process for additional meals/snacks for the day. This allows user to see acknowledge the day's summary nutritional content and adequacy.

In one embodiment the user may access a set of personal data and sub-programs designed to give the user interactive help with different areas. The present invention contemplates that the user may choose to work with health goals and such examples would include weight reduction, cholesterol reduction, and/or stabilization of blood sugar or other health measurements feasible with data in database. The program may in some embodiments correlate the “goals” with any and/or all of the food/menu/recipe information and provide feedback as to whether this particular food/menu/recipe choice and/or information will achieve stated goals. For example, if a user is 20 pounds overweight according to user entered data, and the stated goal is to lose weight, or even the stated goal is to lose 30 pounds, and a daily menu chosen and/or suggested by the program has more than the recommended daily allowances of calories for the user's height, age and activity, level, etc. the program would alert the user. In one embodiment the user may select alternative choices for menu items and/or food items. In one embodiment the program, may suggest alternatives for particular menu/food/recipe items, such as using non-fat butter instead of real butter.

The invention contemplates that the user may use a barcode reader or other input means such as manual entry to scan food items barcode in a store for input into the program for quantitative and qualitative consideration by the system against the recipes. The input means may allow for partial food items, such as ½ an apple, or weight. For example, if the recipe calls for a cup of 2% fat milk, the user may scan a gallon of 1% milk and the program may allow input as to the quantity of milk and provide nutritional information as to the change in the meal or recipe due to the change in the fat content.

In another embodiment of the invention, the user may provide input into the program using a barcode scanner or other means of a multitude of varied food items, even unrelated food items, such as manual entry and the program may suggest a menu based on the inputted items and amount. This system allows for an electronic monitoring of the kitchen stock and may also suggest menus and/or recipes given the amount and quantities of food present. This embodiment of the invention may serve particularly well for the planning of menu items by third parties such as parents helping their college children monitor and provide for proper nutrition while away from home, children assisting with adult parent's menus and menu selection/preparation for toddlers.

In one embodiment the invention optionally allows for the nutrition content of each ingredient of a particular menu and/or recipe to be displayed on the user interface and optionally the nutritional content of any and/or all of the nutrients. The user may choose a particular ingredient such as butter and request a suggested replacement having the same nutritional content. In another embodiment the user may alter the nutritional content of a nutrient and request a suggested replacement that may provide the changed nutrient value. The replacement may be the same ingredient in a different amount, a different ingredient in the same amount or both. Soy may be suggested instead of beef, if protein is desired but cholesterol is a problem. This process may also allow user to compare like foods in such a way that best nutritional content by brand name may be selected. Each time a user makes a change in the program parameters such as an ingredient, the program may store the change and provide updated information regarding that particular recipe or menu and update the system with regards to the total nutritional goal. System may prompt user to select an easily sorted, user-friendly naming convention for ease in future reference and queries.

The user interface may provide an interactive menu allowing the user to go back to any step in the process/program and edit by changing, deleting, adding, etc. the previous entries, choices, etc. In one embodiment the system may provide graded levels of user interaction. For example level 1 would provide for a simple menu choice and not require a lot of input or decision making steps, and level 10 might encompass all of the embodiments present in the invention. In one embodiment the user has at least three different levels of user interaction. Level 1 may provide Item comparison, Recipes and Menus for the generally healthy individual (defined as having no known maladies, allergies or other issues that would suggest using a special diet. The second level may provide Recipe and Menus based upon minimal data of age, gender, height, weight and Food Allergies. The third and subsequent levels may provide recommendations based upon a panel of personal health data entered by the user, saved in the user specific profile name and protected by login and password chosen and kept by the said user. Multiple variations on the customizations may be incorporated. One having ordinary skill in the art will appreciate that the more steps and more input/decision making necessary will result in a higher “grade”. If this embodiment is used, the user will have the option to choose what level he/she/they will use.

In one embodiment of the invention the user may have the option to input particular choices for the method to use such as brand names, organic items, locally produced items defined by a particular geographic area with parameters set by the user, color, texture, packaging choices such as bulk foods, frozen, canned, etc. and the program may attempt to use those parameters in the menu/recipe choices.

In some embodiments the system displays a Graphic “view” of parameters entered above, so consumer may visually view progress.

In other embodiments the system may generate “Health Prompts” which alerts user of actions necessary on their part. Examples include scheduling doctor's appointments, blood pressure readings, laboratory tests and health screenings/measurements specific to user's own medical condition and background. In some embodiments the system has the ability to generate-mails or other means of notification to an outside party, such as a health provider on any information in the system, such as progress made. The system may also allow a “summary health data” using “Continuity of Care” document data standards which would be transmitted to health provider via secure e-mail, e-faxing, printing, or other methods, assuming appropriate measures for protection and security of any personal health data have been implemented.

In some embodiments the system may query the user to select a specific item and identify which grocer by locality usually stocks the item or has the item in stock.

Summary health data using “Continuity of Care” document data standards which would be transmitted to health provider via secure e-mail, e-faxing, printing, or other electronic transmission techniques to be developed in the future.

In general embodiments one having ordinary skill in the art will appreciate the usefulness of a menu item providing help for any query not understood and the user may interact with the help menu such that data providing explanations for any of the queries may be explained and values suggested. The user may skip this portion of the program by responding to an appropriate query from the program. One having ordinary skill in the art will appreciate the need to periodically and systematically store and back up the user input and information for recall and to prevent data loss. The program may have a security feature providing protection by user ID and password.

The methods disclosed herein are usable by the user in any units or language that is desirable and appropriate including metric and English system.

All patents, publications and disclosures disclosed herein are hereby incorporated by reference in their entirety for all purposes.

What is claimed is:

1. A computer-readable medium encoded with a computer program to perform a method for diet selection based on nutrition informatics, said method comprising:
a. setting a user profile,
b. correlating nutrition information with a menu, a food item or a recipe,
c. changing one or more of said nutrition information, menu, food item and a
recipe,
d. re-correlate the nutrition information with said menu, food item or recipe.

2. A computer-readable medium encoded with a computer program as claimed in claim 1, wherein:
the method suggests at least one of a menu, a food item or a recipe by analyzing the user profile with a set of instructions designed to optimize at least one parameter in the user profile.

3. A computer-readable medium encoded with a computer program as claimed in claim 1, wherein:
the method correlates nutrition information for each ingredient of a recipe with said ingredient,
at least one ingredient of said recipe is changed from the recipe,
the method suggests a replacement for the changed ingredient having nutrition information similar to that of the changed ingredient.

4. A computer-readable medium encoded with a computer program as claimed in claim 3, wherein:
the method suggests at least one of a menu, a food item or a recipe by analyzing the user profile with a set of instructions designed to optimize at least one parameter in the user profile.

5. A computer-readable medium encoded with a computer program as claimed in claim 1, wherein:
the method correlates nutrition information for each ingredient of a recipe with said ingredient,
at least part of the nutrition information is changed,
the method suggests a replacement ingredient that has nutrition information similar to that of the changed nutrition information.

6. A computer-readable medium encoded with a computer program as claimed in claim 5, wherein:
the method suggests at least one of a menu, a food item or a recipe by analyzing the user profile with a set of instructions designed to optimize at least one parameter in the user profile.

7. A method for diet selection based on nutrition informatics, said method comprising:
a. setting a user profile,
b. correlating nutrition information with a menu, a food item or a recipe,
c. changing one or more of said nutrition information, menu, food item and a recipe,
d. re-correlate the nutrition information with said menu, food item or recipe.

8. A method for diet selection based on nutrition informatics as claimed in claim 7, wherein:
the method suggests at least one of a menu, a food item or a recipe by analyzing the user profile with a set of instructions designed to optimize at least one parameter in the user profile.

9. A method for diet selection based on nutrition informatics as claimed in claim 7, wherein:
the method correlates nutrition information for each ingredient of a recipe with said ingredient,
at least one ingredient of said recipe is changed from the recipe,
the method suggests a replacement for the changed ingredient having nutrition information similar to that of the changed ingredient.

10. A method for diet selection based on nutrition informatics as claimed in claim 9, wherein:
the method suggests at least one of a menu, a food item or a recipe by analyzing the user profile with a set of instructions designed to optimize at least one parameter in the user profile.

11. A method for diet selection based on nutrition informatics as claimed in claim 7, wherein:
the method correlates nutrition information for each ingredient of a recipe with said ingredient,
at least part of the nutrition information is changed,
the method suggests a replacement ingredient that has nutrition information similar to that of the changed nutrition information.

12. A method for diet selection based on nutrition informatics as claimed in claim 11, wherein:
the method suggests at least one of a menu, a food item or a recipe by analyzing the user profile with a set of instructions designed to optimize at least one parameter in the user profile.
